(19) United States
(12) Patent Application Publication
(10) Pub. No.: US 2010/0291848 A1
(43) Pub. Date: Nov. 18, 2010

(54) Device for Separating Paint Overspray

(75) Inventors: Werner Swoboda, Boeblingen (DE); Erwin Hihn, Walddorfhaeslach (DE); Jurgen Hanf, Tuebingen (DE); Kersten Link, Grafenau (DE); Apostolos Katefides, Gaertringen (DE)

Correspondence Address: FACTOR & LAKE, LTD, 1327 W. WASHINGTON BLVD., SUITE 5G/H, CHICAGO, IL, 60607, US

(73) Assignee: EISENMANN ANLAGENBAU GMBH & CO. KG, Boeblingen (DE)

(21) Appl. No.: 12/670,564

(22) PCT Filed: Jul. 10, 2008
(86) PCT No.: PCT/EP2008/005620

§ 371 Date: Jun. 29, 2010

(30) Foreign Application Priority Data
Jul. 25, 2007 (DE) 10 2007 036 553.7

(51) Int. Cl. B05B 15/12

(52) U.S. Cl. 454/53

(57) ABSTRACT

A device for separating paint overspray from the air of painting cubicles that is laden with overspray has in a housing at least one separating element, the surface of which is electrically conductive and is connected to one terminal of a high-voltage source. The separating element is assigned an electrode arrangement, which is connected to the other terminal of the high-voltage source. The air of the cubicle is made to flow past the separating element and the electrode arrangement in such a way that the overspray particles are colonized and deposited on the surface of the separating element. The separating element is moved continuously or intermittently, wherein a wiping device wipes off the overspray that is on the surface of the separating element. This can then be carried away by a suitable transporting device for disposal or re-use.

The invention relates to a device for separating paint overspray from the air of paint booths which is laden with overspray, having
a) a housing;
b) at least one separating element which is arranged in the housing, it being possible to guide the air of the booth along the surface thereof, as a result of which particles of overspray adhere to the surface, while air that is partly or entirely cleaned flows on;
c) a device by means of which the overspray that has been separated off is carried away from the surface of the separating element.

Hitherto, in the automotive sector wet separation—also called wet scrubbing—has been used almost exclusively for the efficient collection and separation of waterborne or solvent-borne paint overspray, as described for example in EP 0 740 576 B1 or DE 44 01 741.

In general, wet separators of this kind have, below the grating-type floor of the booth, two panels which are inclined towards the centre of the booth and over which water coming from the edge of the booth flows. The water, together with the air of the booth coming from above, flows through an opening between the inner edges of the two panels, and from there goes into a nozzle that accelerates air flow. In this nozzle, the air flowing through is mixed up with the water. During this procedure the overspray particles are largely taken up into the water, with the result that the air leaves the water separator in a substantially clean condition and the overspray particles are in the water. They can then be recovered from this or disposed of.

As mentioned, the principal effect of these wet separators is based on the mixing up of the air and water; admittedly, the water flowing over the floor panels below also takes up a certain proportion of the overspray particles from the air flowing past; so the panels may be called “separating elements” in the above sense. This effect is small by comparison with the principal effect, however.

The known wet separators have the advantage of good cleaning performance with unproblematic operation. However, various disadvantages can be set against this: for example, they need a great deal of energy to circulate relatively large quantities of water and as a result of the loss of pressure at the flow bottlenecks, in particular the accelerating nozzle; the preparation of the rinsing water is costly because of the great use of paint-binding and detackifying chemicals and the disposal of paint sludge; furthermore, the air takes up a very large amount of moisture because of the intensive contact with the rinsing water, which in the circulation operation once again results in high energy consumption of the air preparation.

The object of the present invention is to provide a device of the type mentioned at the outset in which in particular energy consumption is reduced.

This object is achieved according to the invention in that
d) the surface of the separating elements is electrically conductive and is connected to one terminal of a high-voltage source;
e) the separating element is assigned an electrode arrangement which is arranged in the air flow and connected to the other terminal of the high-voltage source;
f) a device is provided by means of which the separating element can be moved continuously or intermittently;
g) the separating element is assigned a wiping device which wipes off the overspray on the surface of the separating element by utilising a relative movement between the separating element and the wiping device.

The present invention thus abandons the basic concept of removing the overspray particles from the air with large quantities of water which are mixed up with the air flow, but rather carries out separation by “dry” means. As a result, all the disadvantages mentioned individually above and associated with the use of water are eliminated. The dry separation takes place on electrically conductive surfaces of separating elements. This separation is made more efficient by ionisation of the overspray particles, which ensures that the overspray particles are electrostatically attracted to the conductive surfaces of the separating elements. To ensure long-term operation of the device, the separating elements and where appropriate the wiping device are movable such that it is possible to present a relatively clean region of surface to the air at all times, while other surface regions are being freed of the deposited overspray by the wiping device.

The separating device may comprise at least one endless belt. Belts of this kind can provide large separating surfaces inexpensively. A certain disadvantage is that the space surrounding the belt is a “dead space”, not making any contribution to the action of separation.

It is particularly advantageous if a plurality of endless belts are provided next to one another. In this way, it is possible to provide even larger surfaces for separating the overspray and to handle even larger air flows.

The runs of the endless belts may be aligned substantially vertically. The reason for this is that in this case the time during which the air and the overspray particles entrained thereby are in the region of the separating elements is relatively long and so the probability that the overspray particles will actually settle on the surface of a belt as a result of the electrostatic force is increased. Moreover, the loss of pressure of the air flow at belts arranged in this way is relatively small.

As an alternative, however, the two runs of the endless belts may also be aligned substantially horizontally. As a result of this, although the throttling action is somewhat increased, the surfaces of the runs are then substantially at a right angle to the direction of flow of the air, with the result that they serve as impact surfaces, which increases the purely mechanical deposition as a result of adhesion.

A compromise between advantages and disadvantages can be reached if the two runs of the endless belts are aligned at an angle of neither 0° nor 90° to the horizontal.

It is particularly advantageous in respect of the action of separation if the endless belts are arranged in a plurality of layers above one another.

This is even more true if the parallel runs of the belts are inclined with respect to the horizontal in opposite directions, in layers above one another.

At least one separating element may also be a rotary roller. Rollers are relatively inexpensive parts. Once again it is a disadvantage that the internal volume of the roller does not make any contribution to the action of separation.

Preferably, a plurality of rollers having parallel axes are arranged next to one another and/or above one another. This measure also serves to increase the separating surfaces and to expand the capacity for separation.

The axis of each roller may extend approximately horizontally. This has the result that the substantially vertical air flow in the booth meets the outer surface of the rollers, which in this way takes on the action of an impact plate, which is advantageous for the efficiency of separation.

As an alternative, the axis of each roller may extend approximately vertically. Although this means that the “impact surfaces” presented by the rollers to the air flow are reduced, it once again increases the dwell time of the overspray particles in the electrical field between the electrode device and the roller.

Once again it is possible to reach a compromise if the axis of each roller extends at an oblique angle to the horizontal that is neither 0° nor 90°. The smaller this oblique angle, the more prominent the “impact action” of the roller outer surface, and the closer the angle is to 90°, the longer the dwell time of the overspray particles in the electrical field.

A further possibility for the construction of the separating element is that of a rotary disc. A disc of this kind is even more inexpensive than belts or rollers and has the additional advantage that the “dead space” is particularly small.

To increase the separating surface, preferably a plurality of discs may be arranged parallel to one another on a common axis.

The axis of each disc may extend approximately vertically. In this case the full principal surfaces of the discs act as impact elements in the above-mentioned sense.

As an alternative, however, it is also possible for the axis of each disc to extend approximately horizontally, which as already mentioned above for the rollers, brings about an increase in the dwell time of the overspray particles in the electrical field.

Once again it is possible to reach a compromise between the two desired but mutually exclusive effects if the axis of each disc extends at an oblique angle to the horizontal that is neither 0° nor 90°.

An advantageous embodiment of the invention consists in at least one separating element taking the form of a rotary screw. With this construction, a conveying action of the separating element in the axial direction can be achieved.

Here, it is advantageous if a doctor arrangement is provided comprising two doctor blades which abut against opposing surfaces of the screw.

If a doctor arrangement of this kind is guided in displaceable manner on a guide rail, then as the screw rotates it is entrained passively, such that in an extreme case a single doctor arrangement is sufficient for the entire screw.

In general, a plurality of electrode arrangements which are connected electrically in parallel and which engage in the gaps between the separating elements and/or the gaps between the separating elements and the walls of the housing should be provided. The number and density of the electrode arrangements is selected such that the overspray particles are as far as possible completely ionised.

The electrode arrangement may take the form of a rectilinear wire or a rod. This simple form ensures that it is inexpensive.

The electrode arrangement may also take the form of a wire or rod which is bent back and forth in a plane, where appropriate a number of times. In this way it attains a nature that is akin to being a surface, which increases the interaction between the electrode arrangement and the air flowing past.

It is also possible for the electrode arrangement to comprise a plurality of electrode tips facing away from one another. It is known that particularly strong electrical fields are produced at tips, and these are particularly conducive to ionisation. Moreover, electrode arrangements of this kind are also easier to clean after a certain period of operation than those comprising thin wires or rods.

An electrode arrangement of this kind may be arranged in the air flow in the booth in front of the separating elements, where they are readily accessible for maintenance purposes in particular.

In a particularly preferred embodiment, an air supply arrangement is provided by means of which at least one electrode arrangement may be supplied with a separate air flow for ionisation, independently of the air in the booth. Ionisation of the air in the booth and the overspray particles that are entrained thereby is in this case at least partially indirect, in that first the air flow that is supplied separately is ionised and then ionisation is transferred from this to the air in the booth and the overspray particles.

It is particularly advantageous if the separate air flow is moistened, since an air flow that is moistened in this way ionises more readily than dry air.

At least one wiping device may be a doctor blade which scrapes the overspray off the surface of at least one separating element. This mechanical means of removing overspray from the surfaces is particularly reliable and unproblematic.

Finally, in an advantageous embodiment of the invention, it is possible to provide at least one arrangement by means of which a wetting fluid may be supplied to the surface of a separating element. This wetting fluid is used only in small quantities, unlike the water in the wet separators mentioned at the outset; it should only moisten the surfaces of the separating elements. A possible wetting fluid is for example an adsorber whereof the task is only to assist deposition of the overspray particles on the surfaces. To prevent the overspray deposited on the surface of the separating elements from becoming solid too soon and so no longer being removable, it is also possible to use solvent or where appropriate even fresh paint as the wetting fluid.

For ionisation of the overspray particles, it may be useful for the high-voltage source to be able to generate pulsed high voltage.

Exemplary embodiments of the invention are explained in more detail below with reference to the drawing, in which:

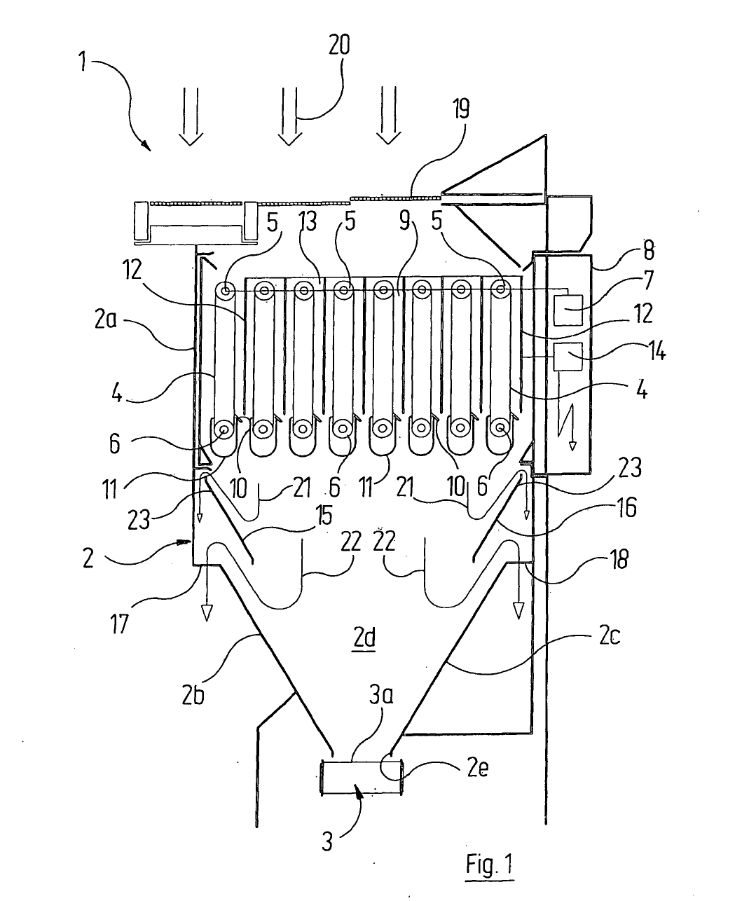

FIG. 1 shows a first exemplary embodiment of an overspray separating device, in vertical section;

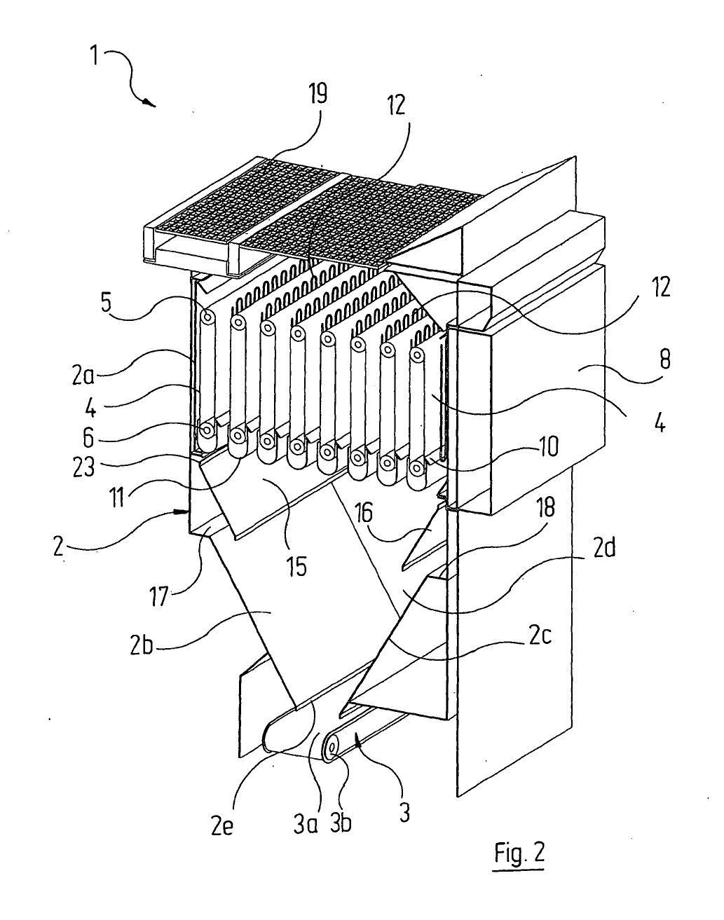

FIG. 2 shows the separating device of FIG. 1 in perspective, with the front wall removed;

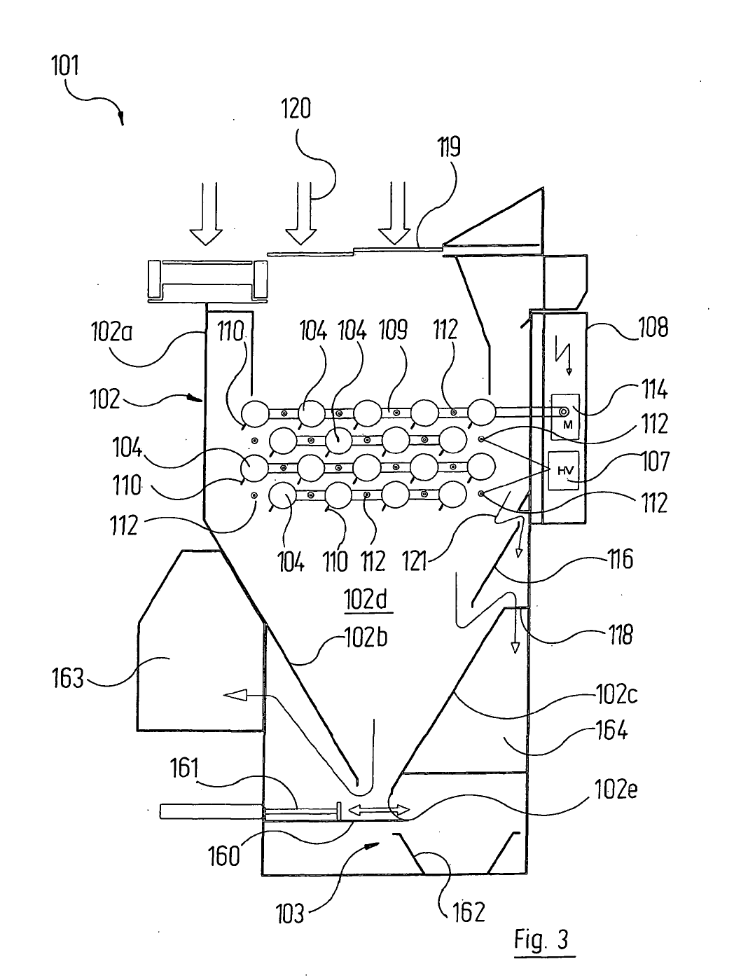

FIG. 3 shows a section, similar to FIG. 1, through a second exemplary embodiment of an overspray separating device;

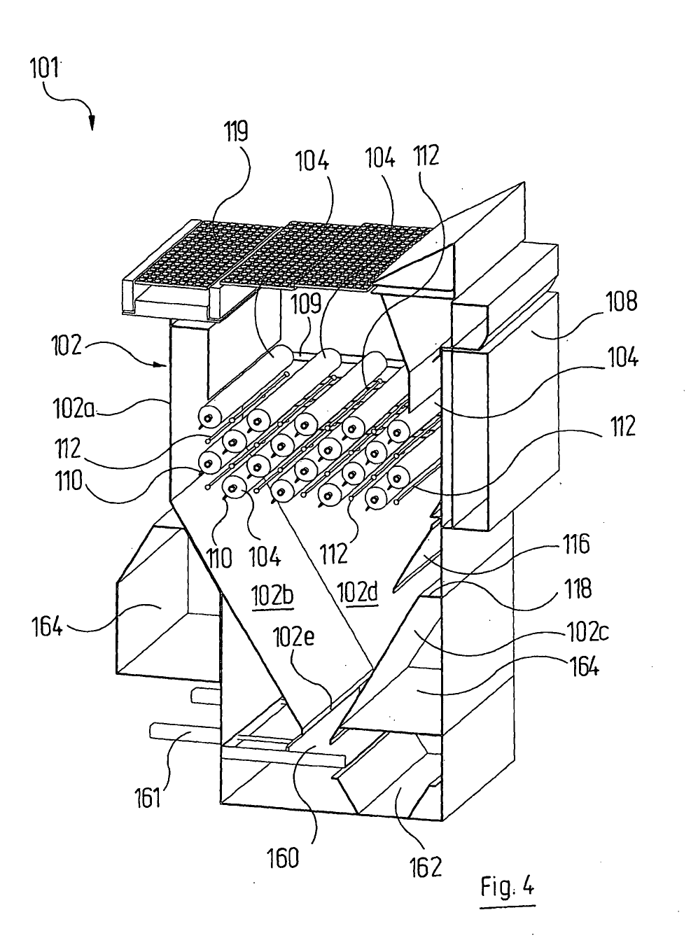

FIG. 4 shows a perspective view, similar to FIG. 2, of the separating device in FIG. 3;

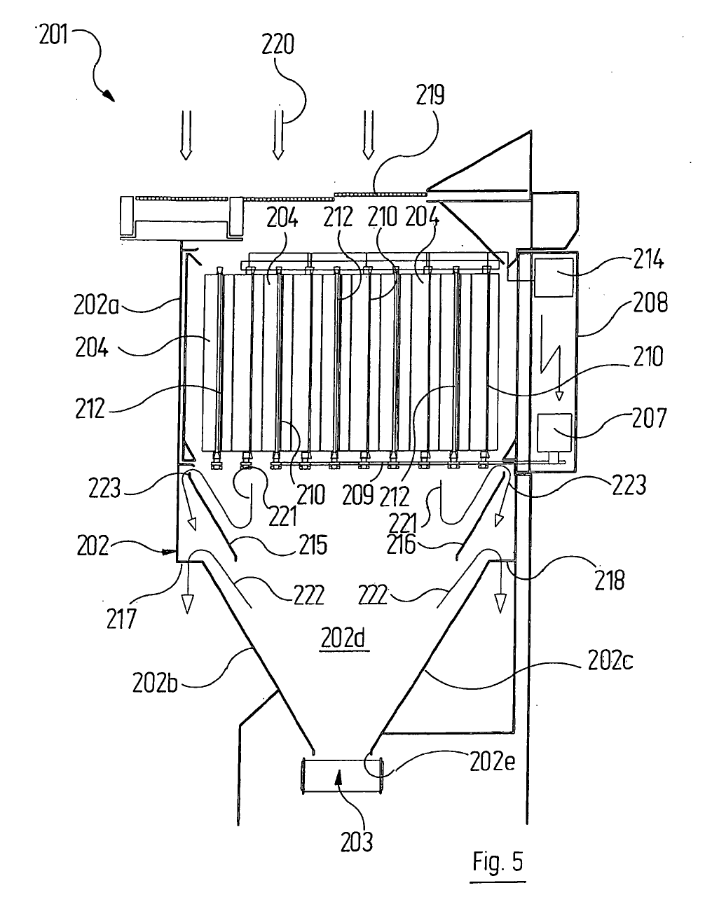

FIG. 5 shows a section, similar to FIGS. 1 and 3, through a third exemplary embodiment of an overspray separating device;

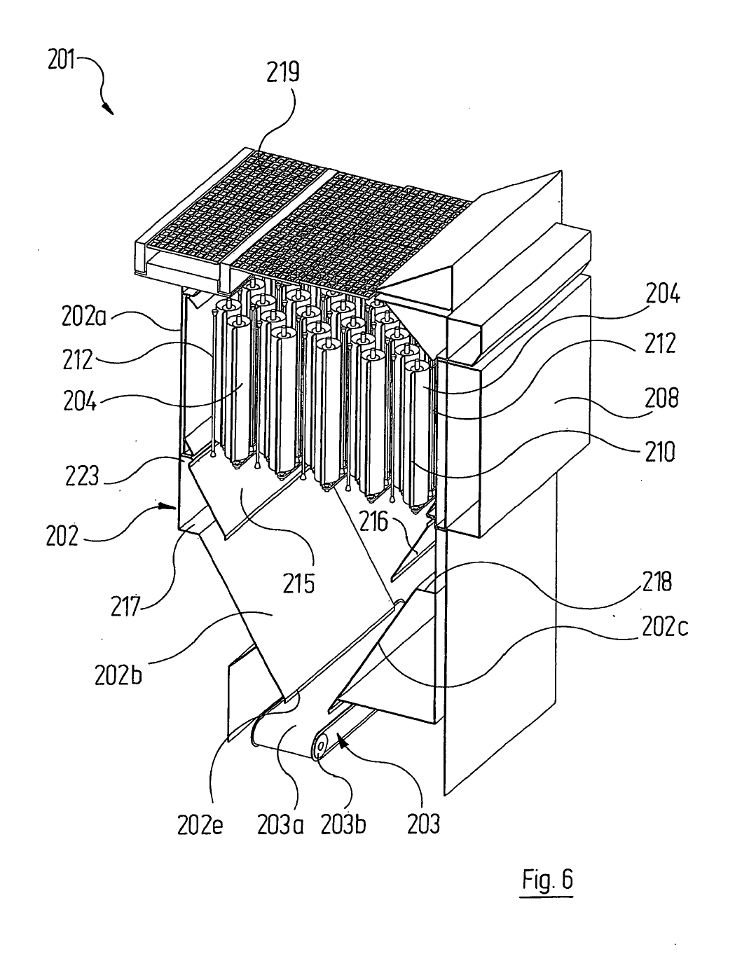

FIG. 6 shows a perspective view, similar to FIGS. 2 and 4, of the separating device in FIG. 5;

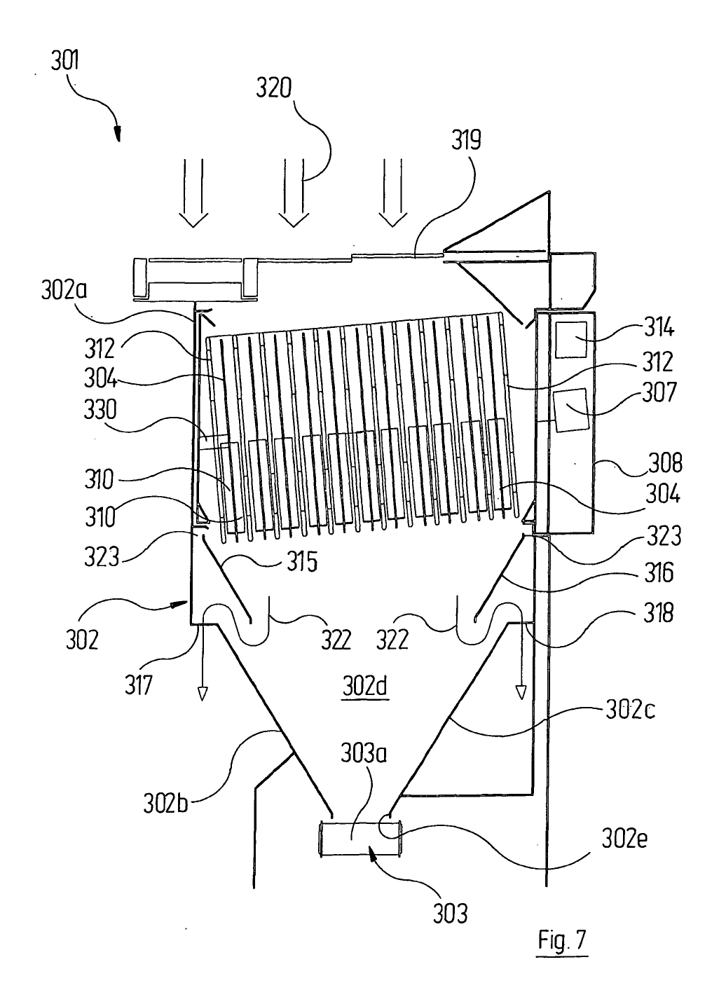

FIG. 7 shows a section, similar to FIGS. 1, 3 and 5, through a fourth exemplary embodiment of an overspray separating device;

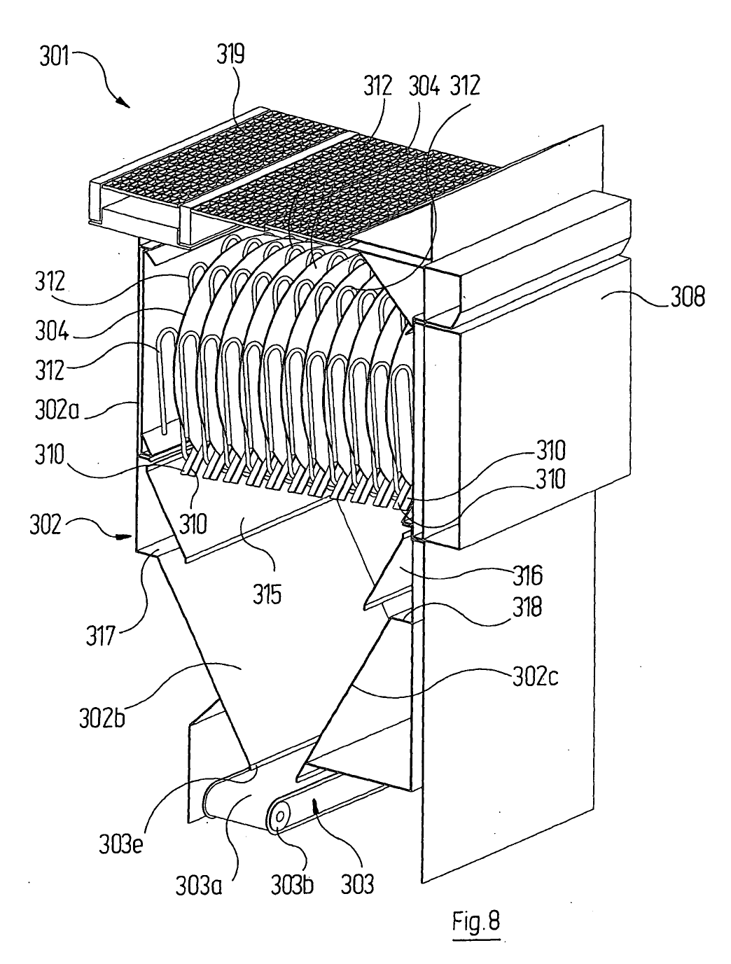

FIG. 8 shows a perspective view, similar to FIGS. 2, 4 and 6, of the separating device in FIG. 7;

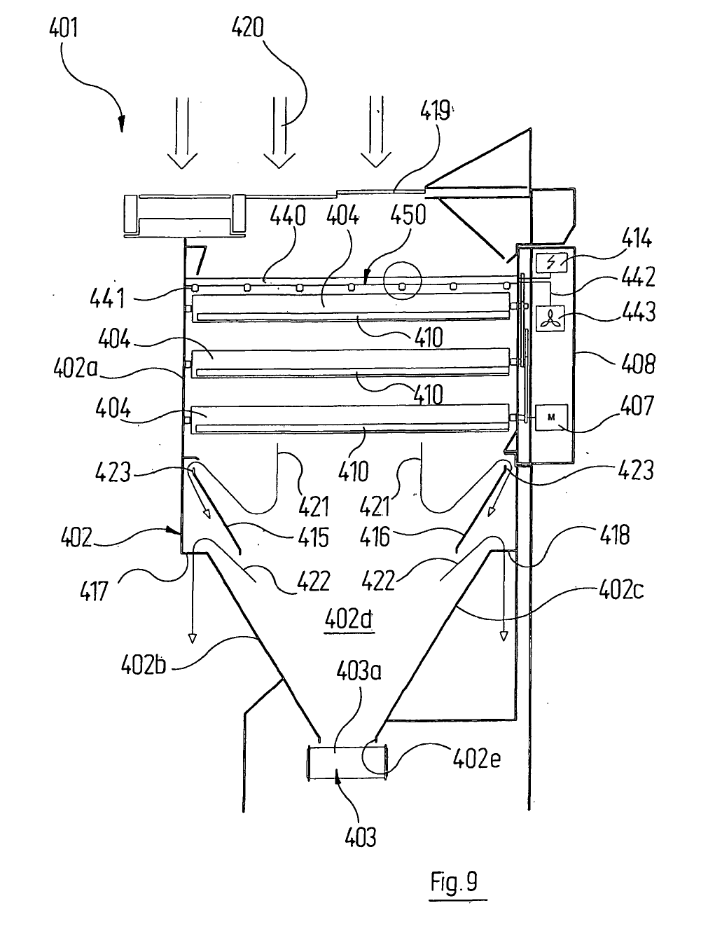

FIG. 9 shows a section, similar to FIGS. 1, 3, 5 and 7, through a fifth exemplary embodiment of an overspray separating device;

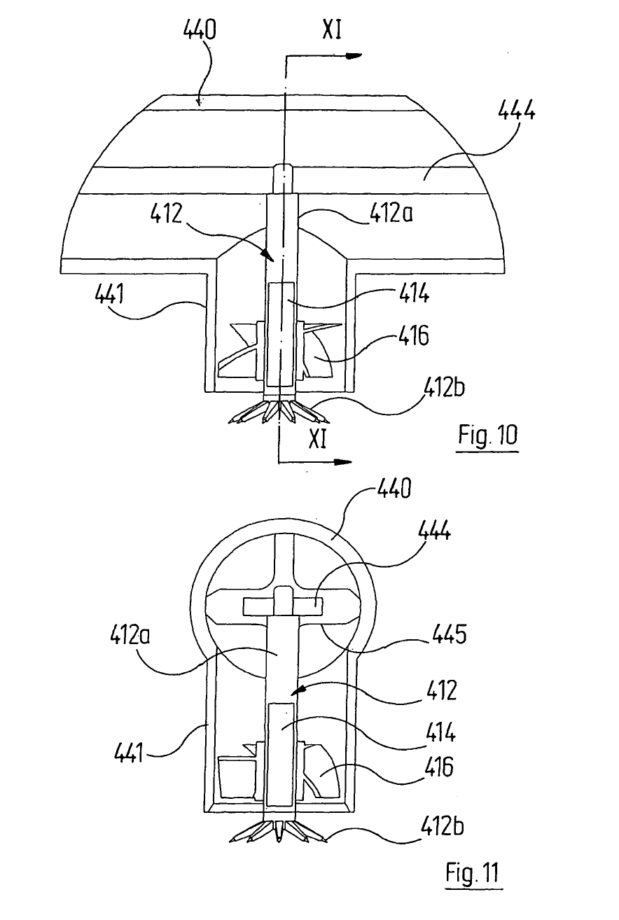

FIG. 10 shows a sectional view of a detail from FIG. 9 on a larger scale;

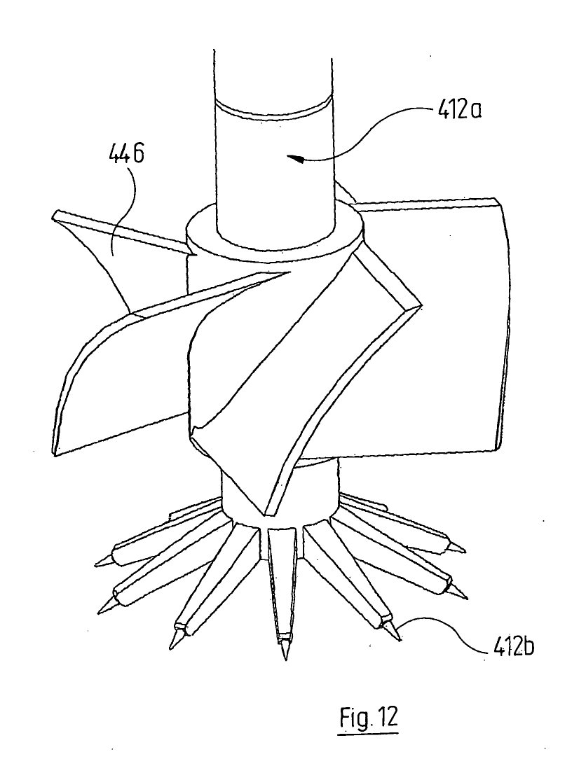

FIG. 11 shows a section along the line XI-XI in FIG. 10;

FIG. 12 shows a detail from FIGS. 10 and 11, in perspective and once again on a larger scale;

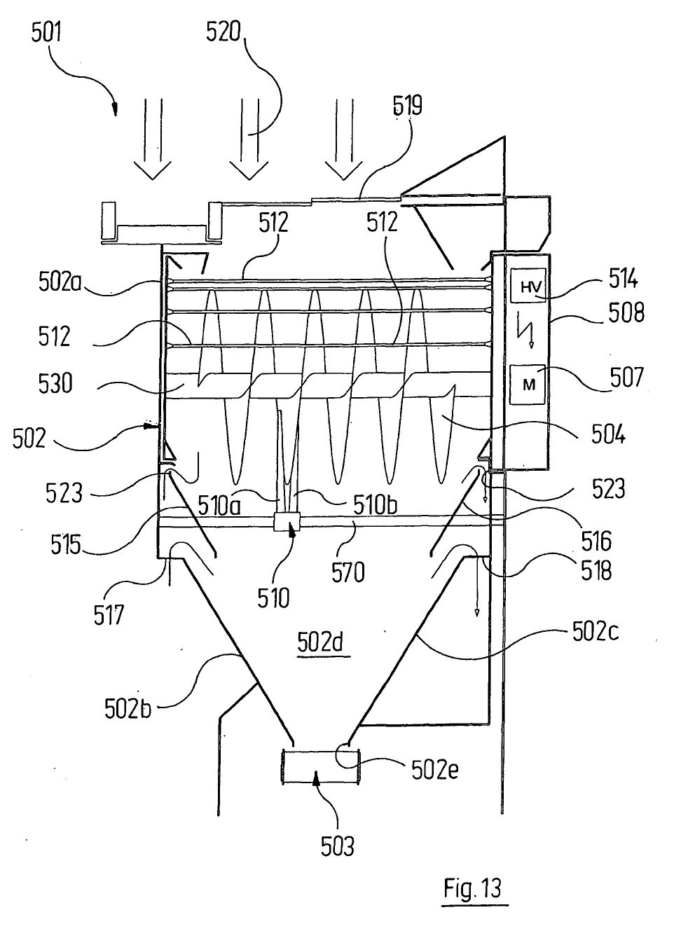

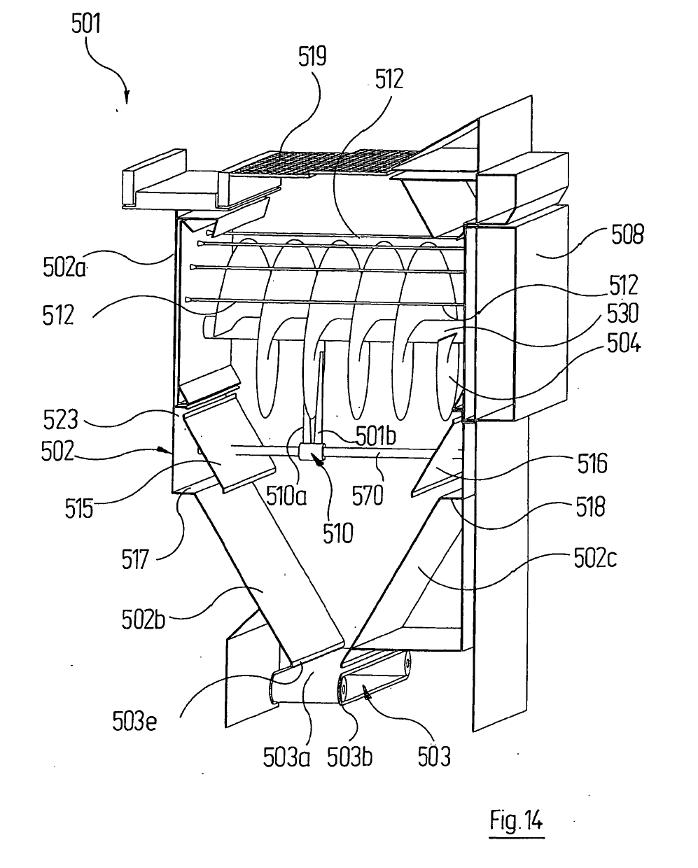

FIG. 13 shows a section, similar to FIGS. 1, 3, 5, 7 and 9, through a sixth exemplary embodiment of an overspray separating device;

FIG. 14 shows a perspective view, similar to FIGS. 2, 4, 6 and 8, of the separating device in FIG. 13;

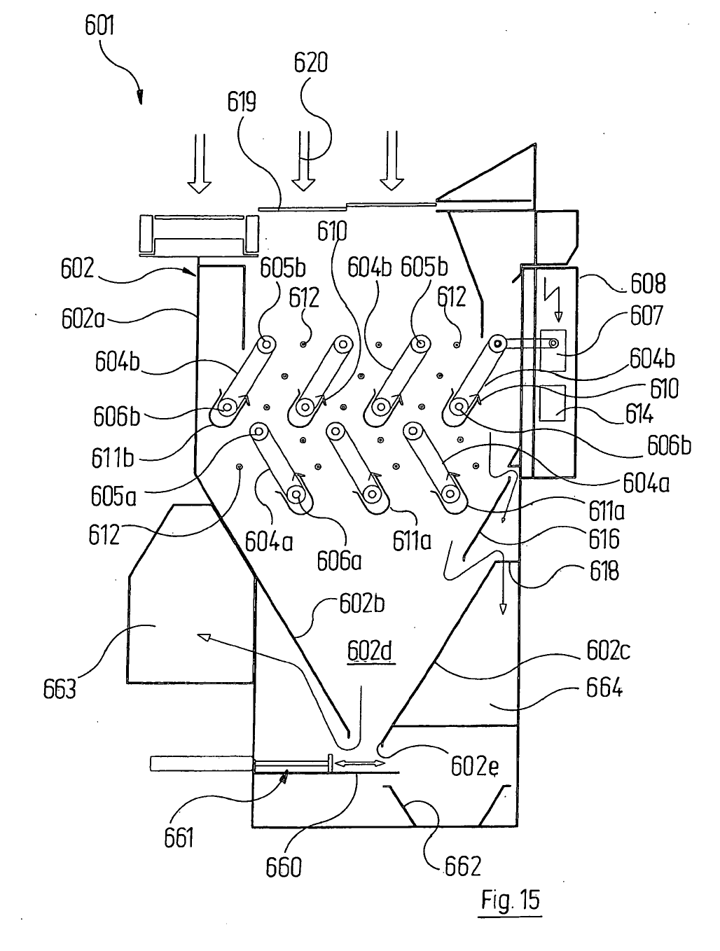

FIG. 15 shows a section, similar to FIGS. 1, 3, 5, 7, 9 and 13, through a seventh exemplary embodiment of an overspray separating device; and

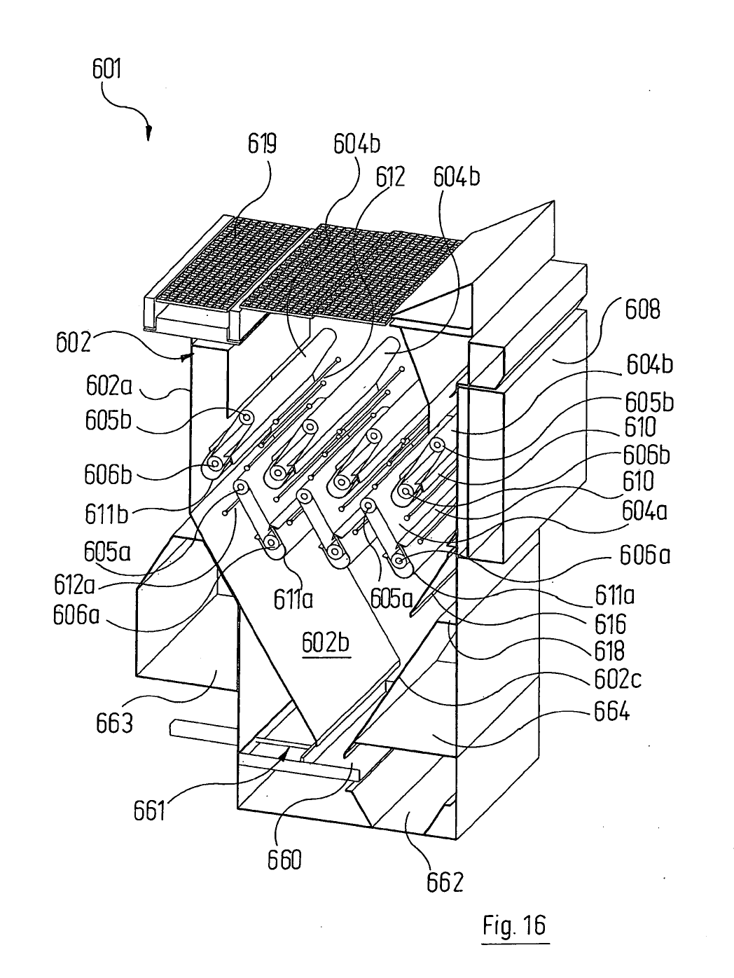

FIG. 16 shows a perspective view, similar to FIGS. 2, 4, 6, 8 and 14, of the separating device in FIG. 15.

Reference is first made to FIGS. 1 and 2. The overspray separating device illustrated here, which is designated overall by the reference numeral 1, comprises a housing 2 which has a rectangular cross-section in its upper region, with exclusively vertical side walls, whereas in the lower region it is delimited by two obliquely downwardly converging side walls 2b, 2c and two vertical end walls 2d (only one being shown in FIGS. 1 and 2). In this way, the lower region of the housing 2 is formed in the manner of a funnel.

A conveyor arrangement 3 is arranged below the exit opening 2e of the “funnel” which is delimited by the lower edges of the housing walls 2b, 2c and 2d. The conveyor arrangement 3 comprises an endless conveyor belt 3a which is guided over two deflection rollers 3b. In FIGS. 1 and 2, only one of these deflection rollers 3b is illustrated; one of the two deflection rollers 3b is driven in known manner.

In the upper, cuboid region 2a of the housing 2, a plurality of endless steel belts 4 are arranged next to one another. All the steel belts 4 are guided over two deflection rollers 5 and 6 which are arranged vertically above one another such that their parallel runs extend vertically. The upper deflection rollers 5 are each driven by a motor 7, which is indicated schematically as a rectangle in a box 8 mounted on the side wall of the housing 2 that is on the right in the figures. The drive connection between the motor 7 and the deflection rollers 5 is indicated schematically by a line 9. This drive connection 9 may be made in any desired manner, for example by way of belts, chains, drive shafts, toothed wheels or the like.

An obliquely positioned doctor blade 10 abuts against the outside of the lower region of the right-hand run of each steel belt 4. A similar doctor blade may also be mounted on the inside of the steel belts 4 (not illustrated).

The lower ends of the steel belts 4 and the deflection rollers 6 located there dip into a respective downwardly closed, upwardly open trough 11 which takes the form of a gutter. The trough 11 may be supplied with a liquid adsorber, solvent, cleaning agent or indeed fresh paint as desired, depending on the paint being used.

Parallel with each of the vertical runs of adjacent steel belts 4 there extends a respective electrode arrangement 12 which, in the exemplary embodiment illustrated, comprises a wire which is bent around 180° a number of times and extends substantially over the entire height and depth of the respective vertical run of the steel belt 4. This can be seen in particular in FIG. 2.

All the electrode arrangements 12 are connected by way of a line 13 to a high-voltage source 14 which is also accommodated in the box 8 on the outside of the housing 2.

Below the steel belts 4 there are two downwardly converging air baffles 15, 16 which extend perpendicular to the plane of the drawing in FIG. 1. In the position between the upper edges of the two oblique lower housing walls 2b and 2c and the lower edges of the vertical housing walls of the upper housing region 2a which are above these there is a respective air exit slit 17, 18.

The upper side of the housing 2 is partly formed by gratings 19 which can be walked on and, to the side, driven on.

The above-described overspray separating device 1 operates as follows:

Booth air laden with overspray particles is supplied to the interior of the housing 2 through the gratings 19 from above, in the direction of the arrows 20. These particles may still be liquid or tacky, or indeed may also be more or less solid. This air also passes into the regions between the vertical runs of adjacent steel belts 4 and, in the case of the two outermost steel belts 4, between the respectively outer run and the adjacent wall of the housing 2. The high-voltage source 14 applies, to all the electrode arrangements 12, a voltage which is high enough to ionise the overspray particles in the air flowing past.

In contrast, the steel belts 4 are earthed; they are moved with the aid of the motor 7. In so doing, in the region of the deflection roller 6 they dip into the wetting fluid in the gutter-like troughs 11. The overspray particles are deposited on the outer surfaces of the steel belts 4 as they pass the latter, with the wetting fluid where appropriate ensuring that the overspray does not become solid on the steel belts 4 too quickly, which would prevent the overspray from being removed from the steel belts 4. It is therefore readily possible for the doctor blades 10 to wipe the overspray that has deposited on the moving steel belts 4 off the latter. The overspray then falls and is guided by the housing walls 2b, 2c to the conveyor arrangement 3 and carried away from there, either to be rejected or reprocessed.

The air that is cleaned of overspray as it passes between the steel belts 4 is guided by the air baffles 15 and 16, some of it upwards in the direction of the arrows 21 and then down again through a respective gap 23 between the upper edges of the air baffles 15 or 16 and the adjacent vertical walls of the housing 2. This portion of the air flow then emerges through the air exit slits 17, 18.

Another portion of the air flow which has passed the various steel belts 4 moves below the lower edges of the air baffles 15, 16 in the direction of the arrows 22 and then also emerges through the air exit slits 17, 18. The cleaned air can then—where appropriate after a certain conditioning procedure—be supplied to the spray booth again. The conditioning procedure may in particular comprise regulation of the temperature or air humidity and where appropriate the removal of solvents.

The exemplary embodiment of an overspray separating device which is illustrated in FIGS. 3 and 4, which is designated overall by the reference numeral 101, is similar to that described above with reference to FIGS. 1 and 2. For this reason, like parts are designated by like reference numerals but incremented by 100.

Identical in the two exemplary embodiments is the construction of the lower, downwardly converging housing walls 2b, 2c; 102b, 102d, the upper gratings 19; 119 and the air exit slit 18; 118.

The main difference between the two exemplary embodiments is in the nature of the moving separating elements. Instead of the endless steel belts 4 from the exemplary embodiment in FIGS. 1 and 2, the exemplary embodiment in FIGS. 3 and 4 comprises a plurality of rollers 104 which are arranged above and next to one another, which have steel outer surfaces and whereof the axes extend horizontally and, in the exemplary embodiment illustrated, lie in four horizontal planes above one another. A plurality of rollers 104 are provided at the same level in each of these planes. Here, the arrangement is such that the rollers 104 in adjacent planes are laterally offset from one another such that the rollers 104 in the lower plane are each mounted below a gap between two rollers 104 in the plane above.

All the rollers 104 are driven by the motor 107 by way of a toothed belt gear 109 which, like the high-voltage source 107, in this exemplary embodiment too is accommodated in a box 108 on the side wall of the housing 102 which is on the right in the drawing.

Each roller 104 is assigned a doctor blade 110 which extends horizontally over the entire length of the roller 104.

Between the planes of the rollers there extend electrode arrangements 112 which either each comprise a plurality of individual wires which extend parallel to the axes of the rollers 104, as in the exemplary embodiment of FIG. 1. The electrode arrangements 112 are electrically connected to the high-voltage source 107.

The air exit slit 17 which is on the left of the drawing in FIGS. 1 and 2 is omitted in FIGS. 3 and 4. Instead, some of the air leaves the lower region of the housing 102 by way of the lower exit opening 102e and is then guided along the outside of the housing wall 102b and up into an air duct 163. Another portion of the air passes through the air exit slit 118, as in the first exemplary embodiment, and from there reaches a second air duct 164. As the two air ducts 163 and 164 continue, they merge and lead to the outside or to an air processing unit.

The conveyor system 103 comprises a drip plate 160, which is mounted directly below the exit opening 102e, and a gutter 162 which is arranged next to it and in which for example a scraper conveyor (not illustrated) moves. A pneumatically operated pusher arrangement 161 serves to push the overspray collecting on the drip plate 160 into the adjacent gutter 162 from time to time.

Operation of the overspray separating device 101 is as follows:

The air laden with overspray particles enters the interior of the housing 102 through the gratings 119, in the direction of the arrows 120. A large proportion of this air meets the outer surfaces of the rotating rollers 104 in the topmost row, which in this way serve as “impact surfaces”. A large proportion of the overspray is already thereby deposited on the outer surfaces of the rollers 104. The air then flows along the outer surface of the rollers 104 into the slit between adjacent rollers 104 of the topmost plane of rollers, and merges there with that portion of the air flowing from above which does not directly impact against the roller outer surface.

The air which has passed the topmost plane of rollers now meets the second plane down of rollers 104. Because the arrangement of the rollers 104 in the two planes is mutually offset in the manner explained above, these air flows meet the outer surfaces of the rollers 104 in the second plane down. Substantially the same procedures are then repeated as the air flows pass through the second roller plane down and the bottommost plane of rollers 104.

The efficiency of deposition of the overspray particles on the rollers 104 is once again intensified by electrostatic means because the overspray particles are ionised as they pass the electrode arrangements 112 and are attracted by the earthed metal outer surfaces of the rollers 104.

The overspray that accumulates on the roller surfaces is wiped away with the aid of the doctor blades 110 and, as in the exemplary embodiment of FIGS. 1 and 2, falls and with the aid of the lower housing walls 102b, 102c is supplied to the conveyor system 103 and falls onto the drip plate 160. From there, it is pushed into the gutter 162 at intervals with the aid of the pusher 161 and from there carried away by the scraper conveyor or in some other way.

The cleaned air moves through the exit opening 102e into the air duct 163 and through the air exit slit 118 into the air duct 164.

The third exemplary embodiment of an overspray separating device 201, which is illustrated in FIGS. 5 and 6, also accords largely with the two exemplary embodiments described above. For this reason, like parts are designated by reference numerals which are incremented by 200 in relation to the first exemplary embodiment.

Completely identical with the exemplary embodiments described above are the housing 202 with the lower, downwardly converging housing walls 202b, 202c, the upper gratings 219, the air exit slits 217, 218 and the conveyor system 203.

Whereas in the second exemplary embodiment, in FIGS. 3 and 4, a plurality of rollers 104 with horizontal axes were provided, in the exemplary embodiment of FIGS. 5 and 6 there are a plurality of rollers 204 which are arranged in the manner of a matrix and whereof the axes are vertical. All the rollers 204 are driven by the motor 207 by way of a toothed belt gear 209. Once again, a doctor blade 210 abuts against a vertical generatrix of each roller 204.

Provided in the gaps between the rollers 204 are a plurality of electrode arrangements 212 which, in this exemplary embodiment, take the form of rectilinear wires or rods. All the electrode arrangements 212 are electrically connected to the high-voltage unit 207.

The operation of this third exemplary embodiment of an overspray separating device 201 is almost identical to that of the exemplary embodiments described above, apart from the details of the flow of air because of the different geometry of the moving separating elements. Thus, in the exemplary embodiment of FIGS. 5 and 6 the air which passes through the gratings 219 into the interior of the housing 202 in the direction of the arrows 220 flows in the vertical direction through the gaps between the vertical rollers 204. The overspray particles are ionised by the electrode arrangements 212 and are attracted towards the earthed metal, in particular steel, outer surfaces of the rollers 204. The overspray deposited there is scraped away with the aid of the doctor blades 210 and falls into the lower region of the housing 202 and ultimately onto the conveyor belt of the conveyor arrangement 203.

The cleaned air leaves the overspray separating device through the air exit slits 217, 218, as in the exemplary embodiments described above.

The fourth exemplary embodiment of an overspray separating device 301, which is illustrated in FIGS. 7 and 8, once again differs from the exemplary embodiments described above only in the nature of the moving separating elements. Those parts of the exemplary embodiment according to FIGS. 7 and 8 which correspond to those of the first exemplary embodiment are provided with the same reference numeral incremented by 300.

Instead of endless steel belts or horizontal or vertical rollers, the exemplary embodiment 301 comprises a plurality of circular discs 304 whereof the opposing principal surfaces serve primarily as separating surfaces. All the discs 304 are seated on a common shaft 330 which can be rotated by a motor 307. The connection between the motor 307 and the shaft 330 is not illustrated in detail in the drawing.

Between the individual discs 304, provided parallel thereto, are electrode arrangements 312 which in this case take the form of a plurality of wires bent into a U shape.

Each disc 304 is assigned two doctor blades 310 which abut against opposing principal surfaces of the respective disc 304.

Operation of the overspray separating device 301 in FIGS. 7 and 8 is once again substantially the same:

The air, which is supplied in the direction of the arrows 320, passes through the gratings 319 and into the gap between the rotating discs 304. Because these discs 304 are placed obliquely in relation to a vertical alignment, a large proportion of the air does not simply flow past the principal surfaces of the discs 304 but meets these principal surfaces and is deflected there such that the discs 304 at the same time act as impact plates. Similarly to the exemplary embodiment with the horizontal rollers 104, just the fact of this impact of the air flow has the result that some of the overspray is deposited on the principal surface of the discs 304 against which it flows. The separating action is moreover improved on an ongoing basis by the fact that the electrode arrangements 312 ionise the overspray particles, which are then attracted by the earthed discs 304.

The overspray that accumulates on the principal surfaces of the discs 304 is wiped away with the aid of the doctor blades 310 and falls such that it can ultimately be carried away by the conveyor system 303.

The cleaned air leaves the housing 302 of the overspray separating device 301 through the air exit slits 317, 318.

The exemplary embodiment of an overspray separating device 401 illustrated in FIGS. 9 to 12 differs from that in FIGS. 3 and 4 only in the alignment of the rollers 104; 404 and the electrode arrangement 112; 412. This means in particular that the two exemplary embodiments accord with one another completely in respect of the construction of the housings 102; 402, the gratings 119; 419, the air exit slits 117, 118; 417, 418, the transport system 103; 403 and the doctor blades 110; 410.

The axes of the rollers 404 in FIG. 9 extend perpendicular to the axes of the rollers 104 in FIG. 3. Moreover, in FIG. 9 the roller axes are arranged in five planes. Of these five planes, however, only three are illustrated. For reasons of clarity, the two planes in between have been omitted from the drawing.

Instead of straight or bent wires extending between the rollers 404, however, in the exemplary embodiment of FIG. 9 an ionisation device 450 which is arranged above the topmost plane of rollers 404 is used. This ionisation device 450 comprises a plurality of tubes 440 which extend parallel in a horizontal plane and are provided at regular axial intervals with downwardly pointing outlet branches 441. Air can be supplied through a line 442 to the interiors of the tubes 440 by way of a blower 443. This air may be booth air or indeed air that has been conditioned, in particular moistened.

Inside each of the tubes 440, in the central region and parallel to their axes, is a support strut 444 to which a plurality of electrode arrangements 412 are secured. The support struts 444 are held against the tubes 440 by insulators 445 (cf. FIG. 11). Each electrode arrangement 412 comprises a vertical support tube 412a which is connected at its upper region to the support strut 444, for example by a threaded connection.

A high-voltage source 414, illustrated schematically in FIGS. 10 and 11 as a rectangle, is accommodated in the interior of each support tube 412a. A relatively low voltage is supplied to all the high-voltage sources 414 by way of lines (not illustrated) which extend through the different support struts 444 and support tubes 412a. The high-voltage sources 414 generate high voltage from these supply voltages. The output from the high-voltage sources 414 is connected to star-shaped, downwardly diverging electrode tips 412b which are mounted at the lower end of the support tube 412a.

The lower region of the outer surface of each support tube 412a carries a plurality of air impellers 446, as can be seen in particular from FIG. 12.

To explain operation of the exemplary embodiment of an overspray separating device 401 which is illustrated in FIGS. 9 to 12, it is sufficient to discuss the different nature of the ionisation of the overspray particles and air passed through. This ionisation is as follows:

The air which is laden with overspray particles and reaches the interior of the housing 402 through the gratings 419 passes between the tubes 440 of the ionisation device 412 and then mixes with the air coming from the outlet branches 441 of the tubes 440, which where appropriate is conditioned. In particular, this conditioned air is ionised at the electrode tips 412b, this ionisation then being transferred to the air flowing between the tubes 440 when the air coming out of the outlet branches 441 mixes therewith. As they pass the rollers 404 underneath, the charged overspray particles are then deposited in the same way as in the exemplary embodiment in FIGS. 3 and 4.

The advantage of the ionisation device 450 of the last-described exemplary embodiment 404 over the electrode arrangements 12; 112; 212 and 312 of the other exemplary embodiments is the better possibility of cleaning.

The exemplary embodiment of a separating device which is illustrated in FIGS. 13 and 14 accords in all its structural components with the exemplary embodiment of FIGS. 1 and 2, with the exception of the separating element, the wiping device and the electrode arrangement. Like parts are designated in FIGS. 13 and 14 by like reference numerals to those in FIGS. 1 and 2 but incremented by 500.

The separating element of the separating device 501 in FIGS. 13 and 14 is formed by a screw 504 turned about a shaft 530. The screw 504 is preferably made of steel plate and comprises a plurality of turns and is driven by the motor 507. A doctor arrangement 510 comprises two doctor blades 510a, 510b which abut against opposing surfaces of the screw 504. It is displaceable on a horizontal guide rail 570. The electrode arrangement 512 comprises a plurality of rectilinear wires or rods which extend parallel to the shaft 530 of the screw 504 and lie on a cylindrical generated surface whereof the axis coincides with the axis of the screw 504.

In operation, when overspray is deposited on the two opposing surfaces of the screw 504 it can be scraped off by the two doctor blades 510a, 510b by turning the screw 504. The doctor arrangement 510 is entrained passively during this and moves on the guide rail 510. Again, the screw 504 can turn continuously or intermittently.

The last exemplary embodiment, which is illustrated in FIGS. 15 and 16, is similar in respect of the structure of the separating elements to the exemplary embodiment of FIGS. 1 and 2 and in respect of the structure of the housing and the transport system to the exemplary embodiment of FIGS. 3 and 4. Like parts in FIGS. 15 and 16 are designated by like reference numerals to those in FIGS. 1 and 2 but incremented by 600.

The separating elements in FIGS. 15 and 16 are once again circulating endless steel belts 604. Here, they are arranged in two “layers” 604a and 604b above one another. The steel belts 604a in the lower layer are laterally offset from the steel belts 604b in the upper layer, such that the upper deflection rollers 605a of the lower steel belts 604a lie in the gap between and below the lower deflection rollers 606b of the upper steel belts 604b. The parallel runs of the upper steel belts 604b and the lower steel belts 606a are inclined with respect to the vertical in opposing directions, such that the side view in FIG. 15 produces a type of herringbone pattern. This arrangement ensures that the air flow laden with overspray cannot simply flow past the runs of the steel belts 604a, 604b but meets them and is deflected thereon.

In all the exemplary embodiments, the type of conveyor system, air guidance and electrode arrangement can be altered in any desired way as long as the objective of the operation is achieved. Instead of a downwardly open housing funnel below which a conveyor system is arranged, it is also possible to provide a closed trough in which a scraper arrangement carries away the accumulated overspray.

Instead of a constant direct current, a pulsed direct current may also be applied to the electrode arrangements.

In all the exemplary embodiments described above, the air flows vertically downwards. However, separating devices in which the direction of the air flow is horizontal are also conceivable. In this case, the separating devices described may be used turned through 90° such that the direction indicated as vertical becomes horizontal and the direction indicated as horizontal becomes vertical. Turning through angles other than 90° is also conceivable.

1. A device for separating paint overspray from the air of paint booths which is laden with overspray, having
a) a housing;
b) at least one separating element which is arranged in the housing, it being possible to guide the air of the booth along the surface thereof, as a result of which particles of overspray adhere to the surface, while air that is partly or entirely cleaned flows on;
c) a device by means of which the overspray that has been separated off is carried away from the surface of the separating element;
wherein
d) the surface of the separating element is electrically conductive and is connected to one terminal of a high-voltage source;
e) the separating element is assigned an electrode arrangement which is arranged in the air flow and connected to the other terminal of the high-voltage source;
f) a device is provided by means of which the separating element can be moved continuously or intermittently;
g) the separating element is assigned a wiping device which wipes off the overspray on the surface of the separating element by utilising a relative movement between the separating element and the wiping device.

2. A device according to claim 1, wherein at least one separating device is an endless belt.

3. A device according to claim 2, wherein a plurality of endless belts are provided next to one another.

4. A device according to claim 2, wherein the two runs of the endless belts are aligned substantially vertically.

5. A device according to claim 2, wherein the two runs of the endless belts are aligned substantially horizontally.

6. A device according to claim 2, wherein the two runs of the endless belts are aligned at an angle of neither 0° nor 90° to the horizontal.

7. A device according to one of claims 2, wherein the endless belts are arranged in a plurality of layers above one another.

8. A device according to claim 8, wherein the parallel runs of the belts are inclined with respect to the horizontal in opposite directions, in layers above one another.

9. A device according to claim 1, wherein at least one separating element is a rotary roller.

10. A device according to claim 9, wherein a plurality of rollers having parallel axes are arranged next to one another and/or above one another.

11. A device according to claim 9, wherein the axis of each roller extends approximately horizontally.

12. A device according to claim 9, wherein the axis of each roller extends approximately vertically.

13. A device according to claim 9, wherein that the axis of each roller extends at an oblique angle to the horizontal that is neither 0° nor 90°.

14. A device according to claim 1, wherein at least one separating element is a rotary disc.

15. A device according to claim 14, wherein a plurality of discs are arranged parallel to one another on a common axis.

16. A device according to claim 14, wherein the axis of each disc extends approximately vertically.

17. A device according to claim 14, wherein the axis of each disc extends approximately horizontally.

18. A device according to claim 14, wherein the axis of each disc extends at an oblique angle to the horizontal that is neither 0° nor 90°.

19. A device according to claim 1, wherein at least one separating element takes the form of a rotary screw.

20. A device according to claim 19, wherein it comprises a doctor arrangement which comprises two doctor blades which abut against opposing surfaces of the screw.

21. A device according to claim 20, wherein the doctor arrangement is guided in displaceable manner on a guide rail.

22. A device according to claim 1, wherein a plurality of electrode arrangements which are connected electrically in parallel and which engage in the gaps between the separating elements and/or the gaps between the separating elements and the walls of the housing are provided.

23. A device according to claim 1, wherein at least one electrode arrangement takes the form of a rectilinear wire or rod.

24. A device according to claim 1, wherein at least one electrode arrangement takes the form of a wire or rod which is bent back and forth in a plane, where appropriate a number of times.

25. A device according to claim 1, wherein at least one electrode arrangement comprises a plurality of electrode tips facing away from one another.

26. A device according to claim 25, wherein the electrode arrangement is arranged in the air flow in the booth upstream of the separating element.

27. A device according to claim 1, wherein an air supply arrangement is provided by means of which at least one electrode arrangement may be supplied with a separate air flow for ionisation, independently of the air in the booth.

28. A device according to claim 27, wherein the separate air flow is moistened.

29. A device according to claim 1, wherein at least one wiping device is a doctor blade which scrapes the overspray off the surface of at least one separating element.

30. A device according to one claim 1, wherein at least one arrangement is provided by means of which a wetting fluid may be supplied to the surface of a separating element.

31. A device according to one claim 1, wherein the high-voltage source is able to generate pulsed high voltage.
